(19) United States
(12) Patent Application Publication
(10) Pub. No.: US 2018/0256443 A1
(43) Pub. Date: Sep. 13, 2018

(54) DEVICE FOR EAR MASSAGE

(71) Applicants: Ronald ZIMMERMANN, Telfs (AT); Eduard WINTER, Zirl (AT)

(72) Inventors: Ronald ZIMMERMANN, Telfs (AT); Eduard WINTER, Zirl (AT)

(21) Appl. No.: 15/943,060

(22) Filed: Apr. 2, 2018

Related U.S. Application Data
(63) Continuation of application No. PCT/AT2015/000127, filed on Oct. 6, 2015.

(51) Int. Cl. A61H 21/00; A61H 23/02

(52) U.S. Cl. CPC A61H 21/00; A61H 23/0263; A61H 2205/027; A61H 2201/1215; A61H 2201/149

(57) ABSTRACT

The invention relates to a device for ear massage, comprising a plate with a massage part. The device has two drives which can be controlled independently from each other and are motion-coupled to the plate at least to some extent by means of coupling elements.

The present invention relates to a device for ear massage with the features of the preamble of claim 1.

A generic device for ear massage was published, for example, in WO 2014/037114 A1. There, the massage part is attached to a plate. The plate is moved in a circular motion by means of an eccentric. The resultant, likewise circular movement of the massage part brings about the massaging action.

Improvement is needed here, as only circular movements can be realized through the use of an eccentric. This is to be viewed against the background that, of course, the area of the auricle between the helix, the antihelix, the tragus and the antitragus is not completely circular.

The object of the invention is therefore to provide a device for ear massage which has a broadened repertoire of movements compared with the state of the art.

This object is achieved by a device with the features of claim 1.

This is effected by providing two drives, actuatable independently of each other, which are at least partially movement-coupled to the plate by means of coupling elements.

In principle, all necessary movement patterns can be realized thereby.

A device according to the invention can be used to treat patients, in particular tinnitus patients. However, the applicant's research has revealed that many other syndromes can also be treated successfully with the device according to the invention. These include insomnia, Eustachian tube dysfunctions, tension headache, cervical syndrome (also combined with tinnitus) and cervicalgia (also combined with paraesthesia).

In the case of tinnitus, a disappearance of the annoying sound can often be achieved. In almost all test subjects, however, at least a change in the pitch or volume of the sound occurred, with the result that it was no longer subjectively perceived as annoying.

The positive effect of the device according to the invention is attributed to the stimulation and mobilization of the areas close to the ear as far down as the shoulder area. Effector organs reside in the area of the cervical spine, the facet joints including joint capsule, the musculature and the fasciae, the musculature and musculotendinous unit in the area of the epicranium, forwards towards the muscles of mastication and the soft palate.

The invention can be a device for stimulating the ear and cervical trigger points to counter a tension headache.

Further advantageous embodiments of the invention are defined in the dependent claims.

The coupling elements can be formed as pins, which interact with recesses in the plate.

The drives can be rotary drives, which are preferably implemented electrical.

The drive axles of the drives can be connected to eccentrics, wherein the coupling elements are arranged on the eccentrics. However, it is also possible to use, instead of two drives with eccentrics, in particular connected to coupling elements formed as pins which interact with recesses in the plate, for example two linear drives which utilize the principle of an XY stage. An advantage of the embodiment with eccentrics is that both drives can be arranged stationary in relation to a housing. The additional complexity of the principle of an XY stage, according to which one drive must be movable in relation to the other drive, can thereby be avoided.

At least two degrees of freedom for the movement of the plate are defined by the two drives, actuatable independently of each other. The movement of the plate, as long as it happens in a plane of the plate, has three degrees of freedom (two for translational movements, one for rotations). The third degree of freedom can be defined particularly simply by a guide pin secured to a housing of the device, wherein the guide pin interacts with a further recess in the plate.

An embodiment in which the recesses and/or the further recess are designed in the form of an elongated hole—preferably open on one side—can be preferred. This also represents a particularly simple solution.

The coupling elements can also each have at least one rail—preferably two rails each—which the plate is guided. If the at least one rail belonging to a coupling element is now rotated, for example by means of a rotary drive, the position of the plate bearing the massage part along the at least one rail of me other coupling element can be altered. Embodiments of this type can be designed particularly flat.

The massage part can be detachably secured to the plate. It is thereby possible to replace the massage part and to use massage parts adapted to the respective ear.

In a particularly preferred embodiment, the massage part can be implemented spherical at least in sections. It has been shown that massage parts that are spherical in sections are perceived by many people as being particularly pleasant. It is to be noted that the plate can be mounted movably on the housing of the device. The weight of the plate in such an embodiment is thus not borne by the coupling elements. This also applies to any pressure which is exerted on the plate by the ear to be massaged via the massage part.

Furthermore, it can be particularly preferred that the massage part is mounted spring-loaded—preferably in a direction substantially perpendicular to the plate. This can also be perceived as being particularly pleasant, as it allows the massage part to adapt itself precisely to the relief of the ear. An absorption of the spring-loading can also be provided.

The spring-loading can also have a magnetic field absorption (principle of action of an eddy current brake).

A spring-loading can be particularly simply achieved in that a—preferably cylindrical—sleeve is secured to the plate and a—preferably cylindrical—ram is secured to the massage part, wherein the ram is arranged in the sleeve. The plate can have an opening, through which the ram and/or sleeve passes.

A clearance, which allows the ram to tilt relative to the sleeve, can be provided between the ram and the sleeve. This can bring about a further small flexibility of the massage part, which is likewise perceived as being pleasant. It is to be noted that in this embodiment, no rigid securing between the massage part and the plate is provided. In any case, the movement of the massage part is guided by the plate.

In an embodiment with sleeve and ram, the spring-loaded mounting can be achieved specifically by a spring element which is supported on a base of the sleeve and interacts with the ram to form the spring-loaded mounting. As mentioned, this represents a particularly simple embodiment.

In order to adjust the rigidity of the spring-loading individually, a pretension of the spring element can be adjustable—preferably by means of a screw.

It can also be provided to use more than one massage part on the plate. This also comprises the possibility of mounting each massage part (or groups of massage parts) spring-loaded independently of each other (e.g. with their own sleeve-ram combination).

In a quite particularly preferred embodiment, a cover can be provided which covers the massage part and which is preferably secured to a housing of the device. This cover prevents the massage part from coming into direct contact with the ear to be massaged, preventing the massage part from pulling on parts of the ear (no movements in a plane parallel to the plate). Only a lifting that moves around is then felt by the ear. The friction between the massage part and the cover can generate additional heat, which can likewise be perceived as being pleasant.

A further advantage of the cover can be that the massage part is prevented from penetrating too deeply into the ear.

It is to be noted that the plate need not be completely flat. It can have, for example, curvatures, offsets or the like, which allow for the design situation in the device.

Further advantages and details of the invention are revealed with the aid of the figures as well as the associated description of the figures, in which:

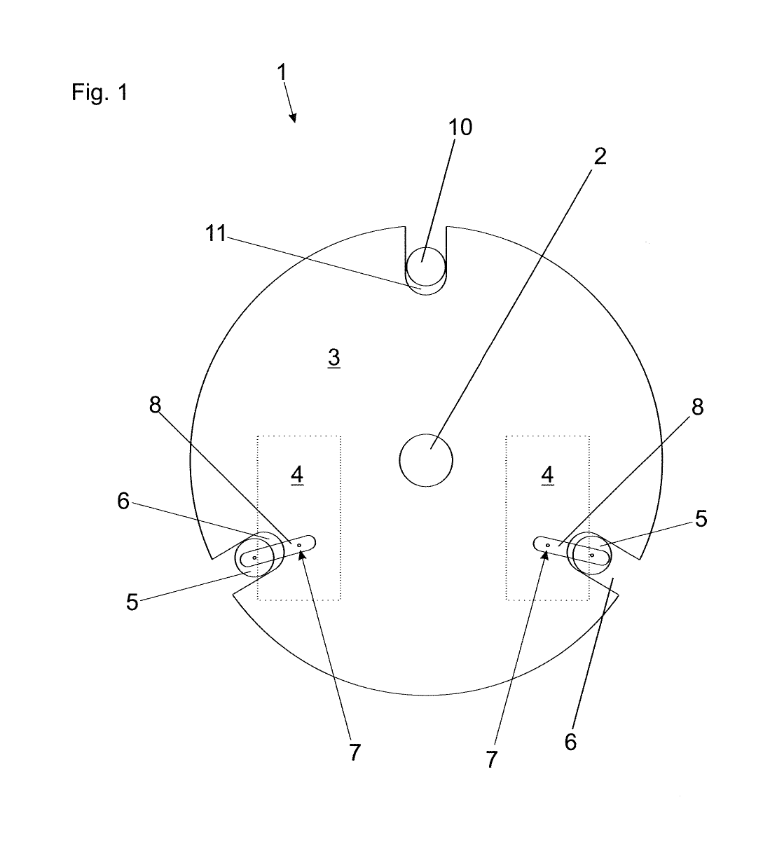

FIG. 1 shows a schematic top view of an embodiment of the invention,

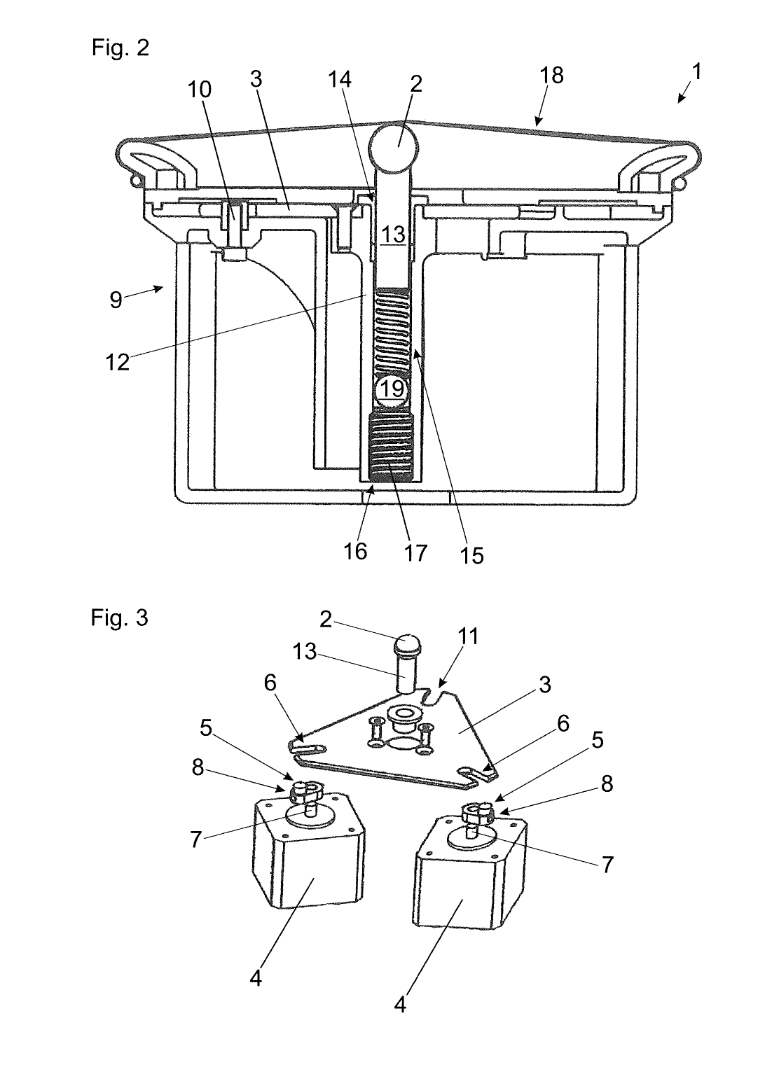

FIG. 2 shows a schematic sectional view of an embodiment of the invention,

FIG. 3 shows essential components of the embodiment from FIG. 2 in a perspective view,

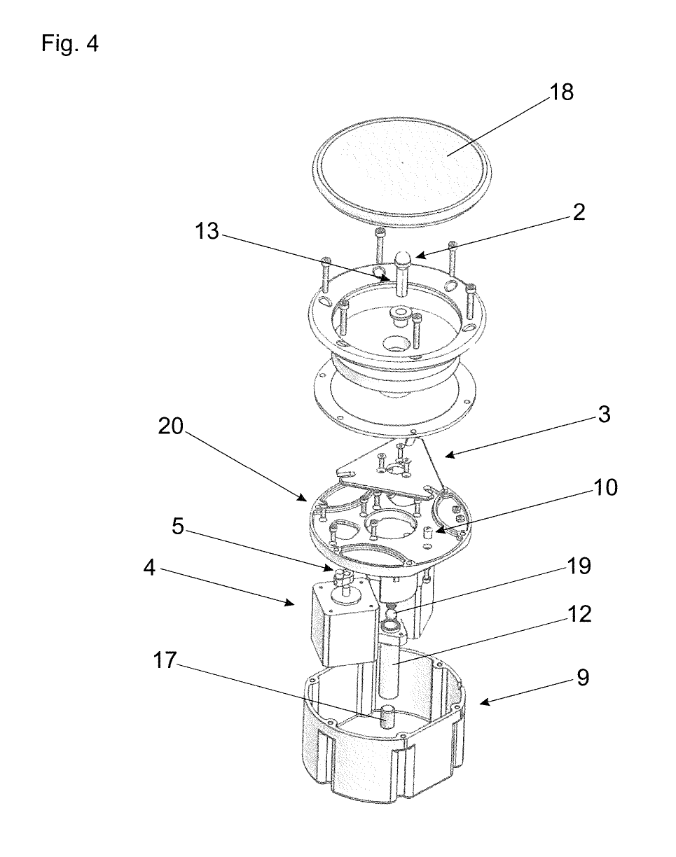

FIG. 4 shows an exploded view of an embodiment of the invention, and

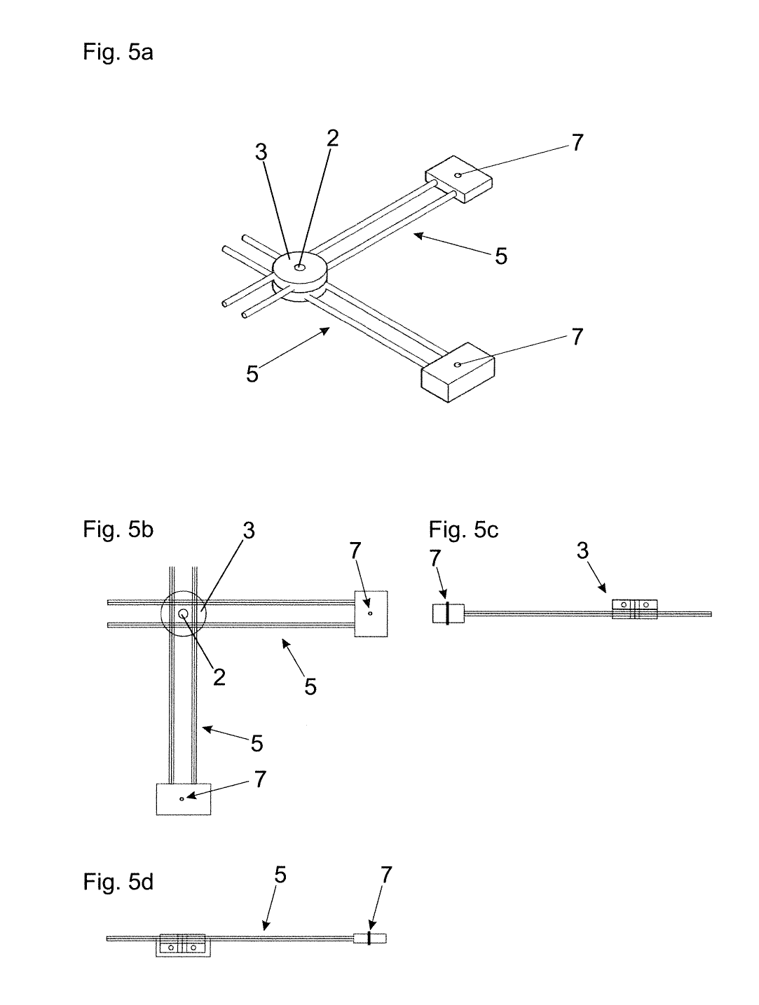

FIGS. 5a-5d show schematic views of a further embodiment of the invention.

FIG. 1 shows a schematic top view to illustrate the drive principle of a first embodiment of the invention. Firstly, the plate 3 can be seen—in this case configured to be circular. The massage part 2 is arranged thereon. There are two drives 4 provided, in this case electrical rotary drives. Their drive axles 7 are each connected to an eccentric 8. Eccentrically relative to the drive axles 7, coupling elements 5 formed as pins are secured to the eccentrics 8.

These coupling elements 5 interact with recesses 6, which are designed as elongated holes open on one side.

The last degree of freedom of the plate 3 (for movements in the plane of drawing) is defined by a guide pin 10, which interacts with a further recess 11.

By this drive design, the movement of the massage part 2 over the area of an auricle, particular an inner auricle, can be particularly finely controlled.

FIG. 2 shows an embodiment of the invention which makes use of the movement principle described in FIG. 1. As can be seen in the sectional view, a spring-loaded mounting of the massage part is also provided. In addition, there is a cover 18, which prevents direct contact between the massage part 2 and the ear to be massaged.

For the spring-loaded mounting of the massage part 2, a sleeve 12 secured to the plate 3 and a ram 13 arranged in the sleeve 12 are provided, wherein the massage part 2 is secured to the ram 13. The spring element 15, which in this case is designed as a coil spring, is arranged in the sleeve 12. The spring element 15 is supported on the base 16 of the sleeve via a ball 19 and a screw 17.

The pretension of the spring element 15 can be adapted by an adjustment of the screw 17 (in this case size M10).

A clearance 14 is provided along a part of the sleeve 12 between the ram 13 and the sleeve 12. This allows the ram 13 to tilt slightly relative to the sleeve 12.

The deformation of the spring element 15, which is generated by this tilting, is compensated for by the ball 19.

Some elements that are essential for the drive of the plate 3 are shown in FIG. 3.

These would be the drives 4 the eccentrics 8, the coupling elements 5, the plate 3 and the massage part 2. The drive principle of this embodiment example becomes clear from looking at FIG. 1 and FIG. 3 together.

FIG. 4 shows an exploded view of an embodiment of the invention which is similar to that of FIGS. 2 and 3. In particular, this embodiment also makes use of the drive principle which was described in connection with FIG. 1. It is to be noted that the housing 9, in which the drives 4 are arranged, has a mounting plate 20. In the assembled state, the drives 4 are secured to the mounting plate 20 (for example by screw connections). The mounting plate 20 is secured to a further, substantially hollow cylindrical part of the housing 9. The mounting plate 20 also serves for supporting the plate 3. It is to be noted that the sleeve 12 is not secured to the mounting plate 20, but to the plate 3.

FIGS. 5a to 5d schematically show a perspective view (FIG. 5a), a top view (FIG. 5b), as well as two side views (FIGS. 5c, 5d) according to a further embodiment. This is an embodiment in which the coupling elements 5 each have two rails. The drives 4 are not shown. These are designed as rotary drives. Via the drive axles 7, it is possible to pivot the rails of the coupling elements 5. As the plate 3 is freely movable along the rails, a pivoting movement of the rails of one coupling element can be used to adjust the position along the rails of the other coupling element.

However, the invention can be realized by more than just the embodiments shown here. For example, the movement in the plane of the plate 3 can also be realized by utilizing the principle of an XY stage. AMENDMENTS TO THE CLAIMS

1. A device for ear massage with a plate having a massage part, wherein two drives, actuatable independently of each other, are provided, which are at least partially movement-coupled to the plate by means of coupling elements.

2. The device according to claim 1, wherein the coupling elements are formed as pins, which interact with recesses in the plate.

3. The device according to claim 1, wherein the drives are rotary drives, which are preferably implemented electrical.

4. The device according to claim 1, wherein drive axles of the drives are connected to eccentrics, wherein the coupling elements are arranged on the eccentrics.

5. The device according to claim 1, wherein a guide pin, which interacts with a further recess in the plate, is secured to a housing of the device.

6. The device according to claim 2, wherein the recesses and/or the further recess are designed in the form of an elongated hole preferably open on one side.

7. The device according to claim 1, wherein the coupling elements each have at least one rail—preferably two rails each—on which the plate is guided.

8. The device according to claim 1, wherein the massage part is detachably secured to the plate.

9. The device according to claim 1, wherein the massage part is implemented spherical at least in sections.

10. The device according to claim 1, wherein the plate is mounted movably on a housing of the device.

11. The device according to claim 1, wherein the massage part is mounted spring-loaded—preferably in a direction substantially perpendicular to the plate.

12. The device according to claim 11, wherein a—preferably cylindrical—sleeve is secured to the plate and a—preferably cylindrical—ram is secured to the massage part, wherein the ram is arranged in the sleeve.

13. The device according to claim 12, wherein a clearance, which allows the ram to tilt relative to the sleeve, is provided between the ram and the sleeve.

14. The device according to claim 12, wherein a spring element, which is supported on a base of the sleeve and interacts with the ram to form the spring-loaded mounting, is arranged in the sleeve.

15. The device according to claim 14, wherein a pretension of the spring element is adjustable—preferably by means of a screw.

16. The device according to claim 1, wherein a cover is provided which covers the massage part and which is preferably secured to a housing of the device.
